(19) United States
(12) Patent Application Publication
(10) Pub. No.: US 2025/0058768 A1
(43) Pub. Date: Feb. 20, 2025

(54) METHOD, COMPUTER PROGRAM PRODUCT, PARKING ASSISTANCE SYSTEM, AND VEHICLE

(71) Applicant: VALEO SCHALTER UND SENSOREN GMBH, Bietigheim-Bissingen (DE)

(72) Inventors: Raman Kavungal Anat, Bietigheim-Bissingen (DE); Martin Hoerer, Bietigheim-Bissingen (DE)

(73) Assignee: VALEO SCHALTER UND SENSOREN GMBH, Bietigheim-Bissingen (DE)

(21) Appl. No.: 18/721,018

(22) PCT Filed: Dec. 12, 2022
(86) PCT No.: PCT/EP2022/085275

§ 371 Date: Jun. 17, 2024

(30) Foreign Application Priority Data
Dec. 16, 2021 (DE) 10 2021 133 413.6

(51) Int. Cl. B60W 30/06

(52) U.S. Cl. CPC B60W 30/06; B60W 2420/403; B60W 2420/408; B60W 2420/54; B60W 2720/10

(57) ABSTRACT

A method for operating a parking assistance system configured for autonomous control of a vehicle includes receiving a plurality of sensor signals from a corresponding plurality of environment sensors arranged on the vehicle. The respective sensor signal is indicative of obstacles in a specific region around the vehicle. A first number of the sensors is indicative of a first side region and a second number of sensors is indicative of a second side region opposite the first. The method also includes determining whether there is an obstacle in the first or second side region, determining a trajectory for the vehicle between the side regions if they are free of obstacles, and autonomously moving along the trajectory.

The present invention relates to a method for operating a parking assistance system, a computer program product, a parking assistance system and a vehicle having such a parking assistance system.

Conventional parking assistance systems are designed to assist a user of a vehicle in parking and unparking. For example, the parking process can take place semi-autonomously, with the vehicle steering automatically but the user controlling the accelerator and the brake. There are also fully autonomous systems known in which the user does not have to do anything themself.

One problem for such parking assistance systems is capture of the surroundings. Especially in dynamic surroundings, in which there are moving objects as well as other road users, the surroundings around the vehicle can change constantly, which is why the surroundings need to be regularly captured, preferably in real time. Conventional parking assistance systems capture the surroundings using ultrasonic sensors in a front and a rear region of the vehicle, for example, said sensors capturing the surroundings in front of and behind the vehicle and also a limited side region in the region of the fenders. However, to the side of the vehicle, the parking assistance system is “blind” when static. When the vehicle is moving at a specific minimum speed, the scanned regions, in particular the regions at the side, can be used to deduce whether there is an object to the side of the vehicle. However, if the vehicle drops below the minimum speed or is stationary, this is not possible, as moving objects can enter the region next to the vehicle at any time. Therefore, during an autonomous maneuver in this state, it is important to ensure that the vehicle first moves forward or backward before making a curve, in order to avoid the “blind” region.

US 2015/0078130 A1 discloses an arrangement of environment sensors on a vehicle that cover a region at the side of the vehicle. The detected sensor signals are used, when the door is being opened by a user of the vehicle, to warn said user if there is an obstacle to the side of the vehicle and/or to prevent or stop the door from being opened in this case.

Against this background, one object of the present invention is to improve the operation of a parking assistance system.

Accordingly, a method for operating a parking assistance system for a vehicle is proposed. The parking assistance system is designed for autonomous control of the vehicle. The method comprises the steps of:
receiving a plurality of sensor signals from a corresponding plurality of environment sensors arranged on the vehicle, the respective sensor signal being indicative of obstacles arranged in a specific region in an area surrounding the vehicle, and a first number of the sensor signals being indicative of a first side region of the vehicle and a second number of the sensor signals being indicative of a second side region of the vehicle opposite the first side region,
determining whether there is an obstacle in the first and/or second side region on the strength of the received first and/or second number of sensor signals,
determining a trajectory for the vehicle that passes through the first or the second side region if it has been determined that the respective side region is free of obstacles, and
initiating autonomous motion along the determined trajectory.

This method has the advantage that the regions at the side of the vehicle are not “blind” regions, and so the parking assistance system can use these regions at the side to determine a trajectory, in particular from a standstill, if they are free. A conventional parking assistance system that cannot detect obstacles in the side regions must drive approximately one vehicle length straight ahead in order to cover the side regions, so that the side regions have been swept by the detection ranges of the sensors on the front or rear of the vehicle. The method is particularly advantageous if the vehicle is parked in a parking space with perpendicular positioning or angled positioning and is supposed to unpark autonomously. In these scenarios, a better trajectory can be taken if the vehicle travels over regions to the side of the parked vehicle, but this is possible only if these regions are free of obstacles. Compared with a vehicle that has sensors at the side but takes account of a detected obstacle only in order to protect the door, the proposed method differs in particular in that the side regions are used for determining a trajectory on the strength of detection of an obstacle.

The parking assistance system is designed for semi-autonomous or fully autonomous control or driving of the vehicle. Semi-autonomous control is understood to mean, for example, that the parking assistance system controls a steering apparatus and/or an automatic gear selection system. Fully autonomous driving is understood to mean, for example, that the parking assistance system additionally controls a drive device and a braking device too. The control takes place in particular on the basis of received sensor signals that are indicative of a driving state of and an area surrounding the vehicle.

The respective number of sensor signals comprises one or more sensor signals. For example, the number is chosen on the strength of the respective sensor technology in such a way that the number can be used to deduce a position of a respective obstacle. For example, three ultrasonic sensor signals are advantageous for this purpose, said signals being able to be used to trilaterate the obstacle. Alternatively or additionally, a single radar signal, lidar signal or image signal from a 3D camera, such as a stereo camera or a TOF camera, may be sufficient for this purpose.

The respective side region extends in particular between a front vehicle axle and a rear vehicle axle on a two-axle vehicle. In the case of a four-door vehicle, the side region includes in particular the door region.

If the parking assistance system determines that there are no obstacles to the side of the vehicle on the strength of the received first and/or second number of sensor signals, the parking assistance system can plan a trajectory including the side regions. If the parking assistance system determines that there is an obstacle in the respective side region, it plans the trajectory in such a way that a collision with the obstacle found is ruled out. This increases both safety in the autonomous driving mode and efficiency of the vehicle. The trajectory that passes through the respective side region also means that the vehicle does not have to move so far forward, and it is thus possible, for example, to avoid using an oncoming lane.

The circumstance that the trajectory passes through the first or the second side region is understood to mean that the vehicle moves through the respective side region at least in places when traveling along the trajectory. For example, a rear wheel of the vehicle rolls through the side region.

The trajectory does not necessarily have to pass through the respective side region if said region is free of obstacles. Rather, the trajectory is planned accordingly if it results in an advantage, such as safer operation of the vehicle and/or a simpler and faster trajectory or the like.

The initiation of the autonomous motion along the determined trajectory comprises outputting appropriate control signals to the respective vehicle systems, such as a steering system in a semi-autonomous driving mode, and additionally a motor in a fully autonomous driving mode.

According to one embodiment of the method, the plurality of specific regions forms a substantially enclosed region around the vehicle.

This means that, based on the received sensor signals, it is possible to determine that there are obstacles arranged somewhere around the vehicle within a specific maximum distance. “Substantially enclosed” means that smaller regions, such as regions up to 5 cm wide, may not be covered.

In embodiments, the plurality of specific regions forms an enclosed region around the vehicle. The enclosed region is in particular completely enclosed.

According to another embodiment of the method, each of the first and/or second number of sensor signals comprises at least three ultrasonic sensor signals.

Based on the three ultrasonic sensor signals, a detected obstacle can be trilaterated so that a position of the obstacle relative to the vehicle can be determined. The three ultrasonic sensor signals come in particular from three different ultrasonic sensors.

According to another embodiment of the method, each of the first and/or second number of sensor signals comprises at least one radar sensor signal, a lidar sensor signal and/or a camera sensor signal.

According to another embodiment of the method, those environment sensors from which the first and the second number of sensor signals are received are active only if a speed of the vehicle is less than or equal to a predetermined upper limit speed, the upper limit speed being selected from a range of 2-60 km/h, in particular 3-30 km/h, preferably being 10 km/h, preferably 7 km/h, more preferably 5 km/h.

This is advantageous because it can save energy and processing power. Further environment sensors, such as those that detect a region to the side of the fender, may continue to be active. Obstacles detected to the side in front of and/or behind the vehicle by these environment sensors can be used to deduce whether there is an obstacle in the respective side region, which is why switching off the aforementioned environment sensors does not have an adverse effect. This embodiment is advantageous in particular for ultrasonic sensors.

According to another embodiment of the method, the method is carried out to autonomously unpark the vehicle, the determined trajectory connecting a parking position of the vehicle to a traveling position of the vehicle.

In the traveling position of the vehicle, in particular the user of the vehicle takes control of the vehicle.

According to another embodiment of the method, the vehicle has not moved for longer than a predetermined minimum period prior to the method being carried out.

When the vehicle is stationary, objects or obstacles can move into the side region of the vehicle. This can happen unnoticed by the environment sensors. Therefore, it can no longer be assumed with certainty that a previously free side region is still free after a predetermined standing time. The predetermined minimum period is, for example, 10 seconds, preferably 5 seconds, preferably 3 seconds.

According to another embodiment of the method, the received first number and the received second number of sensor signals are additionally used to determine whether there is an obstacle in a pivoting region of a door of the vehicle, a predetermined action being carried out if an obstacle has been found in the pivoting region.

This means that the respective environment sensors from which the first and second numbers of sensor signals are received fulfill a dual function, which reduces the complexity of the vehicle and the parking assistance system and saves resources. The predetermined action comprises, for example, outputting a warning message to a user of the vehicle, preventing the door from being opened and/or preventing the door from being opened beyond a predetermined extent. The predetermined extent depends in particular on the distance between the obstacle found and the vehicle.

According to a second aspect, a computer program product is proposed that comprises commands that, when the program is executed by a computer, cause said computer to perform the method according to the first aspect.

The computer forms in particular a parking assistance system.

A computer program product, such as a computer program means, can be used, for example, as a storage medium, such as a memory card, USB stick, CD-ROM, DVD, or provided or supplied in the form of a downloadable file from a server in a network. This can be done, for example, in a wireless communication network by transmitting a corresponding file containing the computer program product or the computer program means.

According to a third aspect, a parking assistance system for a vehicle is proposed. The parking assistance system is designed for autonomous control of the vehicle. The parking assistance system has:
a receiving unit for receiving a plurality of sensor signals from a corresponding plurality of environment sensors arranged on the vehicle, the respective sensor signal being indicative of obstacles arranged in a specific region in an area surrounding the vehicle, and a first number of the sensor signals being indicative of a first side region of the vehicle and a second number of the sensor signals being indicative of a second side region of the vehicle opposite the first side region,
a detection unit for determining whether there is an obstacle in the first and/or second side region on the strength of the received first and/or second number of sensor signals,
a determination unit for determining a trajectory for the vehicle that passes through the first or the second side region if no obstacle has been found in the respective side region, and
a control unit for initiating autonomous motion along the determined trajectory.

The embodiments and features described for the proposed method according to the first aspect apply, mutatis mutandis, to the proposed parking assistance system.

The respective unit of the parking assistance system can be implemented in hardware and/or software. In a hardware implementation, the respective unit may be, for example, in the form of a computer or in the form of a microprocessor. In a software implementation, the respective unit may be in the form of a computer program product, in the form of a function, in the form of a routine, in the form of an algorithm, in the form of part of a program code or in the form of an executable object. Furthermore, each of the units referred to in this document may also be in the form of part of a higher-level control system of the vehicle, such as a central electronic control device and/or an engine control unit (ECU: Electronic Control Unit).

The parking assistance system is designed in particular to carry out the method according to the first aspect.

According to a fourth aspect, a vehicle is proposed. The vehicle comprises a plurality of environment sensors, the respective environment sensor being designed to detect obstacles arranged in a specific region of an area surrounding the vehicle and to output a corresponding sensor signal, and a first number of the environment sensors being designed to detect a first side region of the vehicle and a second number of the environment sensors being designed to detect a second side region of the vehicle opposite the first side region. The vehicle also comprises a parking assistance system according to the third aspect.

The vehicle is, for example, a passenger car or a truck. The embodiments and features specified for the parking assistance system according to the third aspect and the embodiments and features specified for the method for operating a parking assistance system according to the first aspect apply, mutatis mutandis, to the vehicle and vice versa.

According to one embodiment of the vehicle, the plurality of environment sensors comprises one or more ultrasonic sensors, one or more radar sensors, one or more lidar sensors and/or one or more cameras.

According to another embodiment of the vehicle, at least one of the environment sensors of the first number and the second number is arranged on a vehicle side of the vehicle that corresponds to the respective side region.

For example, the respective environment sensor is arranged in a door region of the vehicle, in particular on a door of the vehicle, in a region of a side mirror, in a region of a B pillar and/or in a region of a C pillar.

According to another embodiment of the vehicle, the respective at least one environment sensor is arranged in a section of the vehicle side between a front axle of the vehicle and a rear axle of the vehicle.

According to another embodiment of the vehicle, each of the first number and the second number of environment sensors comprises at least three ultrasonic sensors, the respective three ultrasonic sensors being arranged on the vehicle side that corresponds to the respective side region in such a way that each of them defines a plane.

The respective three ultrasonic sensors can also be said to be arranged in a triangle or to form a triangle. This arrangement allows obstacles to be trilaterated. It is thus possible to determine in particular height information relating to an obstacle, meaning that obstacles that can be driven over, such as a curb, are distinguishable from obstacles that cannot be driven over, such as another road user. The ultrasonic sensors are in particular not arranged in a line.

Further possible implementations of the invention also include combinations of features or embodiments described for the exemplary embodiments previously or hereinafter that are not explicitly mentioned. A person skilled in the art will also add individual aspects to the respective basic form of the invention as improvements or supplementations.

Further advantageous configurations and aspects of the invention are the subject of the subclaims and of the exemplary embodiments of the invention that are described below. The invention is explained in more detail below on the basis of preferred embodiments with reference to the accompanying figures.

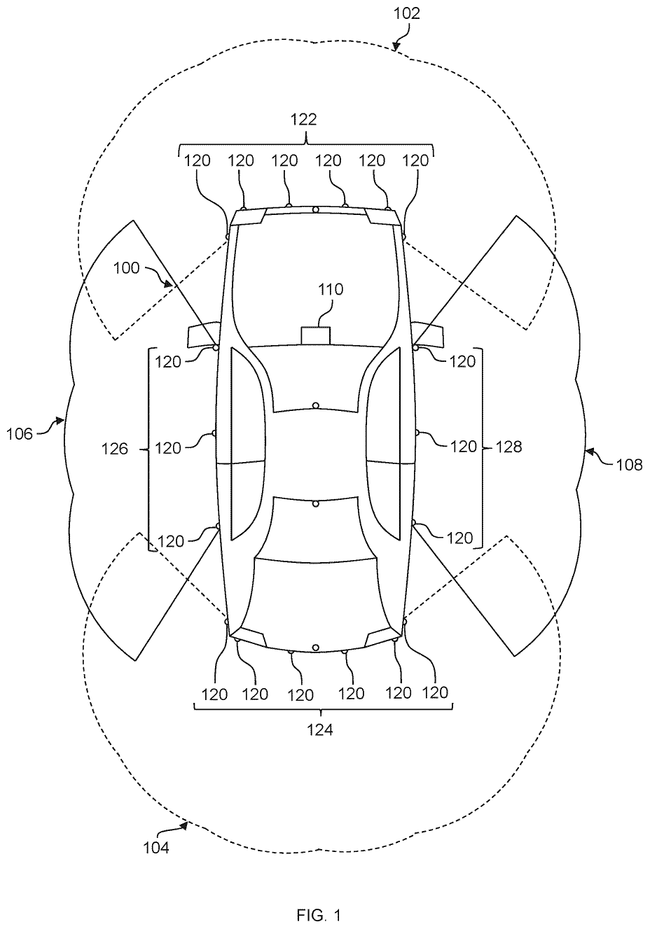

FIG. 1 shows a schematic view of a vehicle;

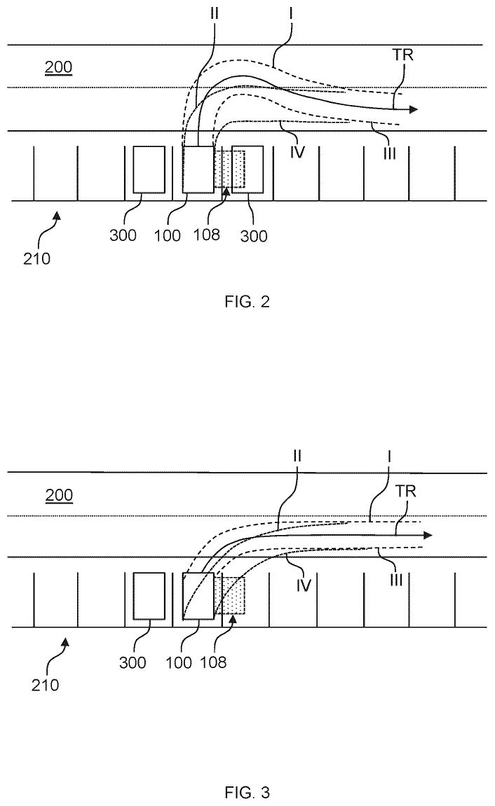

FIG. 2 schematically shows a first traffic situation;

FIG. 3 schematically shows a second traffic situation;

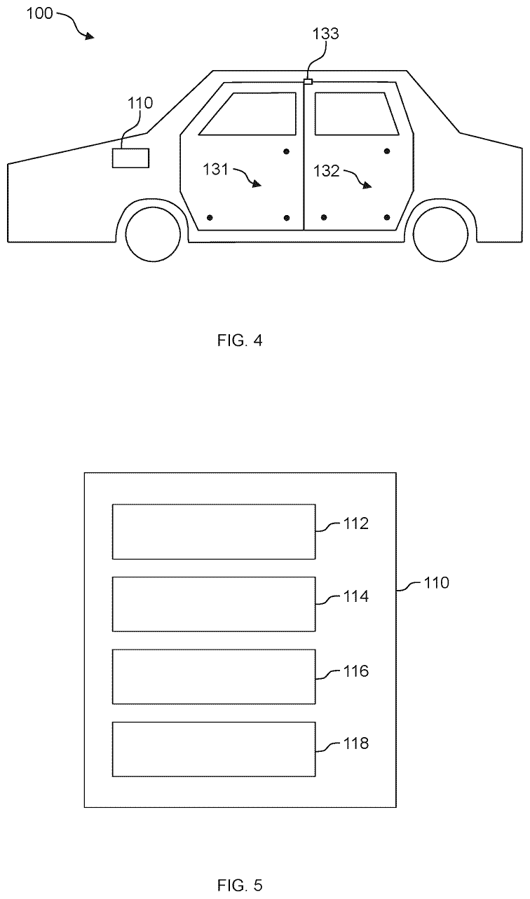

FIG. 4 shows a schematic side view of a vehicle;

FIG. 5 shows a schematic block diagram of an exemplary embodiment of a parking assistance system; and

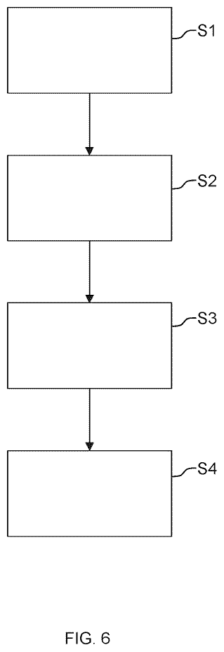

FIG. 6 shows a schematic block diagram of an exemplary embodiment of a method for operating a parking assistance system.

In the figures, identical or functionally identical elements have been provided with the same reference signs, unless otherwise indicated.

FIG. 1 shows a schematic view of a vehicle 100 from a bird's eye perspective. The vehicle 100 is a car, for example. The car 100 has a parking assistance system 110, which is, for example, in the form of a control unit. In addition, multiple environment sensors 120 are arranged on the car 100, which are combined into groups of environment sensors 122, 124, 126, 128 for the purpose of explaining the invention. The respective group 122, 124, 126, 128 has a respective detection range 102, 104, 106, 108. To provide a better overview, the detection ranges 102, 104 on the front/rear of the vehicle 100 are depicted in dashed lines and the detection ranges 106, 108 at the side are depicted using a solid line. It should be noted that combining the environment sensors into groups 122, 124, 126, 128 serves only to provide a better overview; each environment sensor 120 and the respective detection range thereof could also be viewed individually (not depicted).

The group 122 comprises six individual environment sensors 120 and the group 124 likewise comprises six individual environment sensors 120. These are, for example, ultrasonic sensors that collectively form a respective ultrasonic sensor array. The groups 122, 124 are designed to detect obstacles 300 (see FIG. 2 or 3) in the regions 102, 104 arranged in front of and behind the vehicle 100. Each of the regions 102, 104 extends some way around the vehicle 100 to the side, for example as far as, for instance, a front axle and a rear axle of the vehicle 100. The arrangement of ultrasonic sensors 120 in the groups 122 and 124 is known and is used in particular for parking assistance systems, for example to alert the driver to obstacles in front of or behind the vehicle and/or their distance from the vehicle, and/or to provide an autonomous parking function.

However, the regions 102, 104 detected by the known groups 122, 124 are at a great distance from each other to the side of the vehicle 100, resulting, on each side of the vehicle, in a large region that is not detected by these groups 122, 124. In order to also detect obstacles 300 that are present in the respective side region 106, 108, there is therefore provision for two further groups 126, 128 of environment sensors 120. The detection ranges 106 and 108 thereof close in particular the gap between the detection ranges 102 and 104. All of the detection ranges 102, 104, 106 and 108 together thus form in particular an enclosed region around the vehicle 100.

It should be noted that, instead of a respective group 122, 124, 126, 128, there may also be provision for a single environment sensor 120, for example, a single radar sensor, a single lidar sensor or a single 3D camera. In addition, a respective single environment sensor 120 can replace several of the further environment sensors 120 and/or groups 122, 124, 126, 128 if the single environment sensor 120 has an appropriately large detection range. For example, a single radar sensor or lidar sensor arranged on the roof of the vehicle 100 may be sufficient to detect the enclosed region around the vehicle 100.

Furthermore, the car 100 may have various further sensor devices, such as a wheel speed sensor, a wheel angle sensor, a microphone, an acceleration sensor, an antenna with a coupled receiver for receiving electromagnetically transmittable data signals, and suchlike.

The parking assistance system 110 is, for example, in a form like that in FIG. 5 and is designed to perform the method of FIG. 6. Advantages of the parking assistance system 110 are explained below with reference to FIG. 2 and FIG. 3.

FIG. 2 schematically shows a first traffic situation. To the side of a road 200, parking spaces 210 are arranged with perpendicular positioning. On both sides of the vehicle 100, which, for example, is that in FIG. 1, there are obstacles 300. In this example, these are other parked vehicles 300. The side regions 106, 108 thus contain obstacles 300, which are detected by the respective number of environment sensors 126, 128 (see FIG. 1).

In order to unpark the vehicle 100, in this situation the vehicle 100 must first move forward out of the parking space, so that a collision with the vehicle 300 parked next to it is avoided. A corresponding trajectory TR that is planned or determined by the parking assistance system 110 (see FIG. 1 or 5) on the basis of received sensor signals is depicted as an example. The dashed lines I-IV indicate a respective track along which a respective wheel of the vehicle 100 rolls when the vehicle 100 moves out of the parking space according to the trajectory TR. The line I corresponds to the front left wheel, the line II to the rear left wheel, the line III to the front right wheel and the line IV to the rear right wheel. It can be seen that although the side region 108 is essentially not crossed in this case, the vehicle 100 clearly enters the oncoming lane (when traffic drives on the right).

FIG. 3 schematically shows a second traffic situation, which is similar to that depicted in FIG. 2, but no other vehicle 300 is parked to the right of the vehicle 100. The side region 108 next to the vehicle 100 is therefore free of obstacles 300. This is accordingly determined by the parking assistance system 110 on the basis of the sensor signals that are indicative of the right-hand side region 108 of the vehicle 100. Accordingly, the parking assistance system 110 (see FIG. 1 or 5) can plan or determine the trajectory TR for unparking so that the vehicle 100 crosses the side region 108 when unparking. This is depicted by the dashed lines I-IV, which depict a respective track along which a respective wheel of the vehicle 100 rolls. The association between the lines and the wheels is as explained with reference to FIG. 2. In particular, the vehicle 100 can turn in away from a standstill, which means that the rear right wheel rolls through the side region 108. The trajectory TR can also be said to pass through the side region 108. On this trajectory TR, the vehicle 100 advantageously does not enter the oncoming lane; the unparking maneuver is therefore safer.

It should be noted that a conventional parking assistance system that does not receive sensor signals on the basis of which obstacles 300 to the side of the vehicle 100 are detected would have to plan the trajectory TR depicted with reference to FIG. 2 even in this situation in order to ensure that the side region 108 is not crossed. This is because the conventional parking assistance system is not aware of whether or not the side region 108 is free of obstacles 300 due to the lack of appropriate sensor signals.

FIG. 4 shows a schematic side view of a vehicle 100 having a parking assistance system 110. The parking assistance system 110 is, for example, in a form like that in FIG. 5 and is designed to perform the method of FIG. 6. For example, the left-hand side of the vehicle is shown. The vehicle 100 has two doors (without a reference sign). Arranged on each door is, for example, a respective group 131, 132 comprising three ultrasonic sensors, which are depicted as black dots. A respective group 131, 132 is designed to detect obstacles 300 (see FIG. 2 or 3) in a corresponding side region 106, 108 (see FIGS. 1-3) of the vehicle 100. The ultrasonic sensors 131, 132 may be arranged on the vehicle 100 visibly or invisibly. The arrangement in a triangle as depicted here allows trilateration to be used to determine the height of an obstacle 300, so that, for example, a curb is distinguishable from a larger obstacle.

A further environment sensor 133 is additionally shown in the upper region of the B pillar of the vehicle 100. For example, this is a radar sensor or a lidar sensor. This single sensor 133 may be sufficient to completely cover the left-hand side region 106 (see FIG. 1) of the vehicle 100, which means that it can be used, for example, as an alternative to the groups 131, 132. In other words, for example only the sensor 133 may be present and the groups 131, 132 can be omitted without any functional restrictions arising.

FIG. 5 shows a schematic block diagram of an exemplary embodiment of a parking assistance system 110, for example for the vehicle 100 in FIGS. 1-4. The parking assistance system 110 is designed for autonomous control of the vehicle 100. The parking assistance system 110 comprises a receiving unit 112 for receiving a plurality of sensor signals from a corresponding plurality of environment sensors 120, 122, 124, 126, 128, 131, 132, 133 (see FIGS. 1 and 4) arranged on the vehicle, the respective sensor signal being indicative of obstacles 300 (see FIG. 2 or 3) arranged in a specific region 102, 104, 106, 108 (see FIGS. 1-3) in an area surrounding the vehicle 100, and a first number of the sensor signals being indicative of a first side region 106 of the vehicle 100 and a second number of the sensor signals being indicative of a second side region 108 of the vehicle 100 opposite the first side region 106.

The parking assistance system 110 also comprises a detection unit 114 for determining whether there is an obstacle 300 in the first and/or second side region 106, 108 on the strength of the received first and/or second number of sensor signals, and a determination unit 116 for determining a trajectory TR (see FIG. 2 or 3) for the vehicle 100 that passes through the first or the second side region 106, 108 if no obstacle 300 has been found in the respective side region 106, 108, and a control unit 118 for initiating autonomous motion along the determined trajectory TR.

The parking assistance system 110 is designed to perform the method explained with reference to FIG. 6.

FIG. 6 shows a schematic block diagram of an exemplary embodiment of a method for operating a parking assistance system 110 for a vehicle 100 (see FIGS. 1-4), such as the parking assistance system 110 in FIG. 1 or FIG. 5. The parking assistance system 110 is designed for autonomous control of the vehicle 100. A first step S1 comprises receiving a plurality of sensor signals from a corresponding plurality of environment sensors 120, 122, 124, 126, 128, 131, 132, 133 (see FIG. 1 or 4) arranged on the vehicle 100, the respective sensor signal being indicative of obstacles 300 (see FIG. 2 or 3) arranged in a specific region 102, 104, 106, 108 (see FIGS. 1-3) in an area surrounding the vehicle 100, and a first number of the sensor signals being indicative of a first side region 106 of the vehicle 100 and a second number of the sensor signals being indicative of a second side region 108 of the vehicle 100 opposite the first side region 106. A second step S2 comprises determining whether there is an obstacle 300 in the first and/or second side region 106, 108 on the strength of the received first and/or second number of sensor signals. A third step S3 comprises determining a trajectory TR (see FIG. 2 or 3) for the vehicle 100 that passes through the first or the second side region 106, 108 if it has been determined that the respective side region 106, 108 is free of obstacles 300, and a fourth step S4 comprises initiating autonomous motion along the determined trajectory TR.

Although the present invention has been described with reference to exemplary embodiments, it can be modified in a wide variety of ways.

### LIST OF REFERENCE SIGNS

100 vehicle
102 region
104 region
106 region
108 region
110 parking assistance system
112 receiving unit
114 detection unit
116 determination unit
118 control unit
120 environment sensor
122 environment sensors
124 environment sensors
126 environment sensors
128 environment sensors
131 environment sensors
132 environment sensors
133 environment sensors
200 road
210 parking spaces
300 obstacle
I track
II track
III track
IV track
S1 method step
S2 method step
S3 method step
S4 method step
TR trajectory

1. A method for operating a parking assistance system for a vehicle, wherein the parking assistance system is configured for autonomous control of the vehicle, the method comprising:
receiving a plurality of sensor signals from a corresponding plurality of environment sensors arranged on the vehicle,
wherein the respective sensor signal is indicative of obstacles arranged in a specific region in an area surrounding the vehicle, and
wherein a first number of the sensor signals is indicative of a first side region of the vehicle and a second number of the sensor signals is indicative of a second side region of the vehicle opposite the first side region,
determining whether there is an obstacle in the first or second side region based on the strength of the received first or second number of sensor signals;
determining a trajectory for the vehicle that passes through the first or the second side region if it has been determined that the respective side region is free of obstacles; and
initiating autonomous motion along the determined trajectory.

2. The method as claimed in claim 1,
wherein the plurality of specific regions forms a substantially enclosed region around the vehicle.

3. The method as claimed in claim 1,
wherein each of the first and/or second number of sensor signals comprises at least three ultrasonic sensor signals.

4. The method as claimed in claim 1,
wherein each of the first and/or second number of sensor signals comprises at least one radar sensor signal, a lidar sensor signal and/or a camera sensor signal.

5. The method as claimed in claim 1,
wherein the these environment sensors from which the first and the second number of sensor signals are received are active only if a speed of the vehicle is less than or equal to a predetermined upper limit speed,
wherein the upper limit speed is 5 km/h.

6. The method as claimed in claim 1,
wherein the method is carried out to autonomously unpark the vehicle,
wherein the determined trajectory (TR) connecting connects a parking position of the vehicle to a traveling position of the vehicle.

7. The method as claimed in claim 1,
wherein the vehicle has stood still for longer than a predetermined minimum period prior to the method being carried out.

8. The method as claimed in claim 1,
wherein the received first number and the received second number of sensor signals are additionally used to determine whether there is an obstacle in a pivoting region of a door of the vehicle, and a predetermined action is carried out if an obstacle has been found in the pivoting region.

9. A non-transitory computer readable medium comprising program instructions that, when is executed by a computer, cause said computer to perform the method as claimed in claim 1.

10. A parking assistance system for a vehicle,
wherein the parking assistance system is configured for autonomous control of the vehicle
wherein the parking assistance system comprises:
a receiving unit for receiving a plurality of sensor signals from a corresponding plurality of environment sensors arranged on the vehicle,
wherein the respective sensor signal is indicative of obstacles arranged in a specific region in an area surrounding the vehicle, and
wherein a first number of the sensor signals is indicative of a first side region of the vehicle and a second number of the sensor signals is indicative of a second side region of the vehicle opposite the first side region,
a detection unit for determining whether there is an obstacle in the first and/or second side region based on the strength of the received first and/or second number of sensor signals,
a determination unit for determining a trajectory for the vehicle that passes through the first or the second side region if no obstacle has been found in the respective side region, and
a control unit for initiating autonomous motion along the determined trajectory.

11. A vehicle comprising a plurality of environment sensors,
wherein the respective environment sensor configured to detect obstacles arranged in a specific region of an area surrounding the vehicle and to output a corresponding sensor signal,
wherein a first number of the environment sensors are configured to detect a first side region of the vehicle and a second number of the environment sensors are configured to detect a second side region of the vehicle opposite the first side region, and
wherein the vehicle comprises a parking assistance system as claimed in claim 10.

12. The vehicle as claimed in claim 11,
wherein the plurality of environment sensors comprise one or more ultrasonic sensors, one or more radar sensors, one or more lidar sensors and one or more cameras.

13. The vehicle as claimed in claim 11,
wherein at least one of the environment sensors of the first number and the second number is arranged on a vehicle side of the vehicle that corresponds to the respective side region.

14. The vehicle as claimed in claim 13,
wherein the respective at least one environment sensor is arranged in a section of the vehicle side between a front axle of the vehicle and a rear axle of the vehicle.

15. The vehicle as claimed in claim 11,
wherein each of the first number and the second number of environment sensors comprises at least three ultrasonic sensors,
wherein the respective three ultrasonic sensors are arranged on the vehicle side that corresponds to the respective side region in such a way that each of them defines a plane.
